(19) United States
(12) Patent Application Publication
(10) Pub. No.: US 2013/0345835 A1
(43) Pub. Date: Dec. 26, 2013

(54) OPERATING ELEMENT FOR A HOUSEHOLD APPLIANCE, OPERATING UNIT FOR A HOUSEHOLD APPLIANCE THAT HOLDS SUCH AN OPERATING ELEMENT, AND HOUSEHOLD APPLIANCE WITH SUCH AN OPERATING UNIT AND SUCH AN OPERATING ELEMENT

(71) Applicant: MIELE & CIE. KG, (US)

(72) Inventors: Matthias Stahl, Oerlinghausen (DE); Giovanni Castelli, Busto Arsizio (VA) (IT); Edina Bugár, Budapest Hungary (HU)

(73) Assignee: MIELE & CIE. KG, Guetersloh (DE)

(21) Appl. No.: 13/707,622

(22) Filed: Dec. 7, 2012

(30) Foreign Application Priority Data
Dec. 8, 2011 (EP) 11 401 661.1

(51) Int. Cl. G05B 99/00

(52) U.S. Cl. CPC G05B 99/00
USPC 700/83

(57) ABSTRACT

An operating element for a household appliance includes a base part with a projector and a sensor and an operating part that is movable relative to the base part. The projector of the base part is configured to display a selection menu as a function of a position of the operating part, with the selection menu being disposed in physical proximity to the operating element. The sensor is configured to detect a selection made in the selection menu.

### CROSS REFERENCE TO RELATED APPLICATIONS

This application claims priority to European Patent Application No. 11 401 661.1, filed Dec. 8, 2011, which is hereby incorporated by reference herein in its entirety

### FIELD

The invention relates to a device—referred to below as an operating element—for operating a household appliance, especially a stationary household appliance such as, for instance, a washing machine, a dishwasher or the like. The invention also relates to an operating unit of a household appliance that holds such an operating element, and finally, it also relates to a household appliance with such an operating unit and such an operating element.

### BACKGROUND

Devices for operating household appliances are generally known. A common example for washing machines or dishwashers is an operating unit having a program-selection knob and one or more switches or pushbuttons and the like. European patent application EP 1 814 003 A1 discloses a household appliance in which, in order to operate the household appliance, a display device projects a virtual actuation surface that a user actuates contactlessly using a detection means.

### SUMMARY

In an embodiment, the present invention provides an operating element for a household appliance includes a base part with a projector and a sensor and an operating part that is movable relative to the base part. The projector of the base part is configured to display a selection menu as a function of a position of the operating part, with the selection menu being disposed in physical proximity to the operating element. The sensor is configured to detect a selection made in the selection menu.

### BRIEF DESCRIPTION OF THE DRAWINGS

Exemplary embodiments of the present invention are described in more detail below with reference to the drawings, in which:

FIG. 1 shows a household appliance having an operating unit and an operating element,

FIG. 2 also shows a household appliance having an operating unit and an operating element,

FIG. 3 shows an operating element that has been removed from an operating unit, with a display of a selection menu generated by the operating element,

FIG. 4 shows a graphic illustration of a hierarchic organization of a plurality of selection menus,

FIG. 5 shows a snapshot during the use of the operating element, showing the user's hand for actuating the operating element and the user's other hand for making a selection in a projection of a selection menu,

FIG. 6 shows a transmitting coil and a receiving coil as examples of a wireless energy supply for the operating element, and

FIG. 7 shows cause-effect relationships during the use of the operating element.

### DETAILED DESCRIPTION

An aspect of the present invention is to provide additional options for operating a household appliance, particularly options that are especially simple and clear for a user of the household appliance in question.

In an embodiment, the present invention provides an operating element especially for a stationary household appliance of the above-mentioned type, that comprises a base part and an operating part which is movable, especially rotatable, relative to the base part, it is provided that the base part comprises a projector and at least one sensor, it is provided that the projector for displaying a selection menu is arranged and configured as a function of a position of the operating part and is in physical proximity to the operating element in order to display a selection menu, and it is provided that the sensor can detect a selection made in the selection menu.

Therefore, in contrast to the solution proposed in the above-mentioned European patent application EP 1 814 003 A1, it is provided that the operating element comprises a base part and that the projector and the sensor or each sensor are associated with the base part, and it is provided that the operating element comprises an operating part by means of whose position different selection menus can be opened so as to be displayed. Furthermore, it can be provided that the operating element can be removed from the household appliance in question and it can be used remotely from the household appliance for purposes of selecting and/or influencing at least one function of the household appliance.

In an embodiment of the operating element, it comprises means to detect a position of the operating part as well as means to choose a selection menu and to actuate the projector to display the chosen selection menu. A possible means to detect a position of the operating part, especially in the case of a rotating operating part, is a commonly known circuit having a potentiometer or a so-called incremental encoder. A possible means to choose a selection menu and to accordingly actuate the projector is a functionality configured as software and/or hardware or firmware. This functionality compares an input signal—which is generated, for instance, by an incremental encoder and which encodes a position of the operating part—to values or value ranges that encode prescribed and possible different positions of the operating part in order to generate a signal that is correlated with a given position of the operating part, or else to generate a corresponding, internally processable value. Then, with the signal or internal value, the selection menu determined by the position of the operating part can be selected in a storage unit containing the data that is available there for numerous selection menus. This data is fed to the projector, yielding a visual display of the selection menu.

In a special embodiment of the operating element, a camera functions as the sensor for detecting a selection in a given selection menu that is being displayed, whereby a selection in the selection menu can be detected by processing an image captured by the camera. Particularly when the projector and the camera are in close proximity to each other on the base part of the operating element, it can be assumed that the camera image essentially matches the image displayed as the selection menu by the projector. If, accordingly, there are only few or no deviations between the camera image and the image displayed as the selection menu by the projector, this can be seen as an indication that the user has not placed a finger or hand in the area of the projected image. If, in contrast, the user wishes to make a selection using a finger or hand, the finger or the hand will be positioned in the area of the captured image and there will be appreciable differences between the camera image and the image displayed by the projector as the selection menu. Then, as an approximation, an image-processing operation in the form of an image subtraction is sufficient so that, by performing such a subtraction of the selection menu from the captured camera image, information can be obtained as to where a finger or hand of the user is present in the area of the selection menu. Since the physical distance between the projector and the camera on or in the base part is known and constant, this physical distance can also be used to offset deviations between the selection menu and the camera image due to different angles of inclination of the appertaining beam path.

Building upon these considerations, it can also be provided that, in the case of an operating element that can be used at a distance from the household appliance, in other words, when the selection menu is being projected onto a kitchen work surface as an example of a place where the operating element can be used, a functionality of the operating element performs a comparison between the projected selection menu and the captured camera image in order to inform the user about projection surfaces that cannot be used or about unfavorable placement locations. For instance, a surface with a highly structured surface might make it more difficult to evaluate the camera image. Thus, when the projected image is subtracted from the camera image (or vice versa), deviations occur everywhere due to the surface structure of the projection surface. If these deviations exceed a certain threshold value, it becomes difficult to distinguish between deviations caused by the surface structure of the projection surface and deviations due to the operating actions being carried out by the user. An unsuitable surface can thus already be recognized before the user attempts to carry out the operating actions. The user is informed about this situation by an optical or acoustic signal generated by the operating element, so that the user can then look for a more suitable placement location for the operating element. By the same token, it can also be more difficult to display the selection menu and/or to evaluate the camera image on a surface that is uneven. Especially in the case of a surface that is uneven, the projected image exhibits distortions and consequently, when the projected image is subtracted from the camera image (or vice versa), possibly considerable deviations occur that can make it difficult or impossible to recognize the operating actions. In such a situation as well, the user can be informed by an optical or acoustic signal about the unsuitable placement location of the operating unit. The same holds true if the operating element has not been placed flat onto the surface, thereby causing a distortion of the projected selection menu.

In order for a selection in a selection menu to be detected, in other words, in order for the position of the user's finger or hand to be ultimately detected relative to the projected selection menu, it is also possible to employ other image-processing functions such as, for example, methods and functions of so-called morphological image processing.

In an embodiment of the operating element, a group of electromagnetic sensors, each oriented in different radial directions, function as a sensor or sensor array for detecting a selection in a selection menu. Such sensors function according to the principle of a conventional motion sensor. In this context, electromagnetic waves (Doppler radar), ultrasound (ultrasonic motion sensor) or infrared light or combinations thereof are emitted and reflections are detected in order to recognize an obstacle, a movement or a heat source in the detection area. Since a group of such sensors is employed and since the individual sensors are each oriented in different radial directions, the position of the user's finger or hand can be detected as an operating action.

An operating element of the type described here as well as below is employed with an operating unit of a stationary household appliance of the above-mentioned type when the operating unit has a docking receptacle for such an operating element and the operating element can be placed on or in the docking receptacle. A source of energy such as for example, a battery, that is contained in the operating element can be charged when the operating element is docked in or on the operating unit.

A special embodiment is characterized in that the operating element is detachably secured, particularly magnetically, in the docking receptacle. Securing the operating element detachably, for example, by means of a latched connection, translates into a reliable contact between the operating unit and the operating element such as is needed, for instance, for inductively charging a battery contained in the operating element. If the detachable operating element is secured magnetically, this has the advantage that the surface sections of the operating element and of the operating unit that are involved in securing the operating element to the operating unit can be smooth or at least without edges, which improves the attractiveness of both parts and especially also the ease with which they can be cleaned. Moreover, detachably securing the operating element magnetically entails a convenient operating effect for the user since, once a certain physical proximity between the operating element and the docking receptacle has been reached, the operating element snaps into its docking receptacle virtually of its own accord and since, when the operating element is removed from the docking receptacle, even though there is first a need to overcome an initial resistance, this resistance is not due to a mechanical deformation or the like as is the case with a latching element. All in all, detachably securing the operating element magnetically in the docking receptacle formed on the operating unit increases the usefulness of the components involved and of the operating concept realized in this manner.

When it comes to a system comprising an operating element and an operating unit as described here as well as below, it can be provided that the operating unit has a transmitting coil while the operating element has a receiving coil, and it can be provided that, in order to supply electric energy to the operating unit, electric energy is transferred by the transmitting coil to the receiving coil, and that the receiving coil is part of a circuit having an electric energy storage unit, in other words, for instance, a battery, so that a current flowing through the transmitting coil induces a current flow into the receiving coil, and this current flow has the effect of charging the electric energy storage unit of the operating element. Therefore, the electric energy storage unit can be charged without a need for electric contacts on the part of the operating unit or of the operating element. Such a wireless energy path can also transmit data to the operating element—for example, by modulating the electric field emitted by the transmitting coil—namely, for instance, image data for the selection menu that is kept on hand in a non-volatile memory of the operating element. Suitable sensor arrays make it possible to ensure that the transmitting coil for transferring energy, or for transferring energy and data, is only active when the operating unit is in the docking receptacle. Options for this include, for example, a so-called reed contact or a Hall sensor, which are known to be influenceable by magnetic fields, so that a permanent magnet provided for detachably securing the operating element magnetically can be detected by a reed contact or a Hall sensor, so that a circuit can be closed in order to activate the transmitting coil.

A special embodiment of a system comprising an operating element and an operating unit in which the operating element can be detached from the operating unit and can be used remotely from the operating unit is characterized in that, in case of its use remotely from the operating unit, data that encodes operating actions can be transmitted from the operating element to the operating unit, especially wirelessly. In a manner of speaking, the operating element becomes a remote control for the household appliance in question, while the operating unit functions essentially like a receiving station for data that encodes operating actions and that has been transmitted by the operating element. Therefore, a surface of the operating unit that is visible on the outside of the household appliance can, in an extreme case, be reduced to a size that is sufficient to provide a docking receptacle for the operating element. The space needed until now for the switches, pushbuttons, program-selection knobs, etc. that have been provided on the operating unit can then be utilized for other purposes.

In a special embodiment of a system comprising an operating element and an operating unit in which the operating element can be detached from the operating unit and used remotely from it, the operating unit and the operating element each have a transmitting and/or receiving means for wireless communication between the operating unit and the operating element. A radio connection, for instance, is an option for the wireless communication, and a transmission according to the standard known under the designation ZigBee can serve as the data-transmission protocol. An alternative would also be the use of an existing electric installation at the location where the household appliance in question is set up, so that the data transmission takes place according to the standard known under the designation in-house power line communication. In order to be supplied with electric energy, the household appliance in question needs a connection to the power network of the house anyway. If the operating element has the appropriate plug contacts, it can also be plugged into a socket connected to the power network of the house, thus allowing data transmission between the operating element and the household appliance, whereby a surface next to or above the socket being used can serve as the projection surface for the selection menu.

Consequently, the invention also comprises a household appliance of the above-mentioned type, having an operating element and/or an operating unit as described here as well as below.

Advantages that can be attained with the invention and its embodiments include the novel operating concept that makes it possible to clearly structure a plurality of operating options and to combine them graphically in the form of projections of displayable selection menus. There are hardly any limitations to the design of the selection menu, so that it can comprise text and/or graphics, that is to say, for instance, so-called icons, thereby allowing the meaning of the individual selection possibilities combined in a selection menu to be recognized quickly and intuitively. The possibility of the graphic display of the selection menu means that there are hardly any limitations in terms of the number of selection menus that can be displayed. Therefore, there is no special need to provide only a few selection menus with a certain number of selection possibilities; on the contrary, selection possibilities that belong together in terms of content or function can be made accessible in a suitable structure of hierarchically organized selection menus. The same wide variety of selection possibilities could only be realized in a conventional set-up by a correspondingly large number of switching elements or by means of complex switching elements for which there would not be sufficient space on the outside of most household appliances.

In the drawings described below, objects or elements that correspond to each other are provided with the same reference numerals in all of the figures. This embodiment or any embodiment should not be construed as a restriction of the invention. Rather, within the scope of the present disclosure, numerous alterations and modifications are possible, particularly those variants and combinations which, in order to achieve the objective, can be gleaned by the person skilled in the art, for example, through the combination or modification of individual features or elements or process steps that have been described generally or specifically and that are contained in the claims and/or in the drawing and that, through combinable features, lead to a new subject matter or to new process steps or process step sequences.

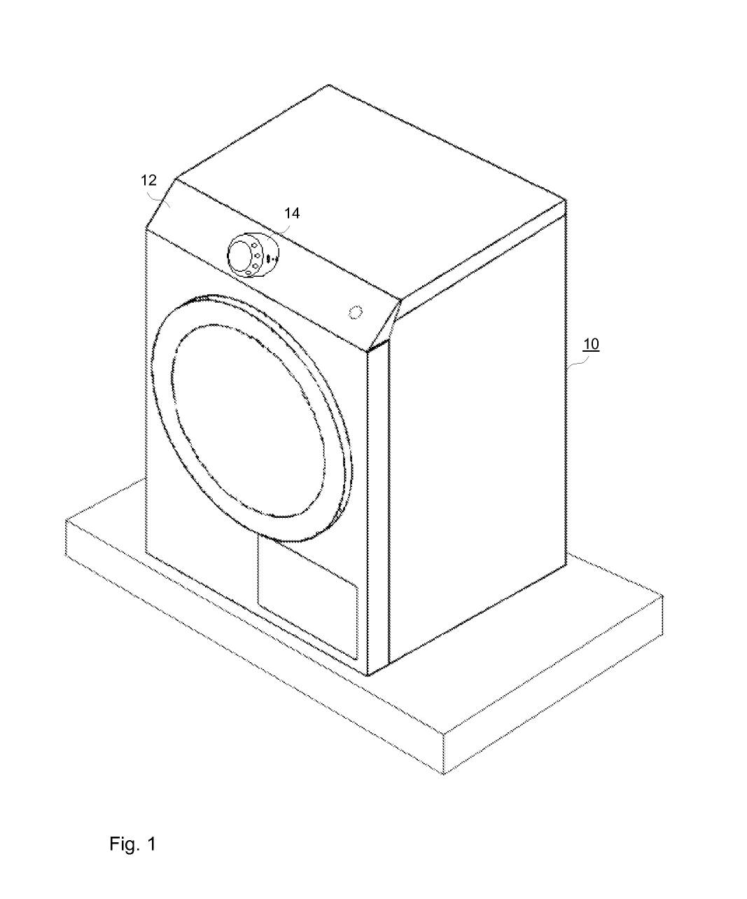

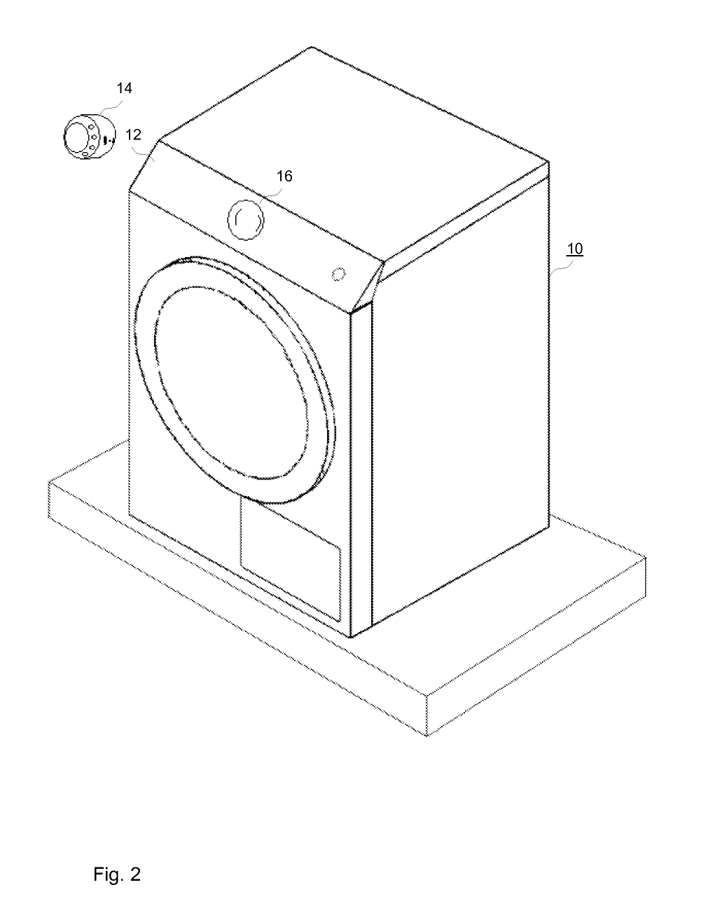

FIG. 1 and FIG. 2 each show a washing machine as an example of a household appliance 10. The household appliance 10 comprises not only the usual components found in a washing machine such as a washing drum, a drive aggregate and so on, but also an operating unit 12 and an operating element 14.

FIG. 2 shows that the operating element 14 can be removed from the operating unit 12 and that a docking receptacle 16 is formed in the operating unit 12 in order to hold the operating element 14.

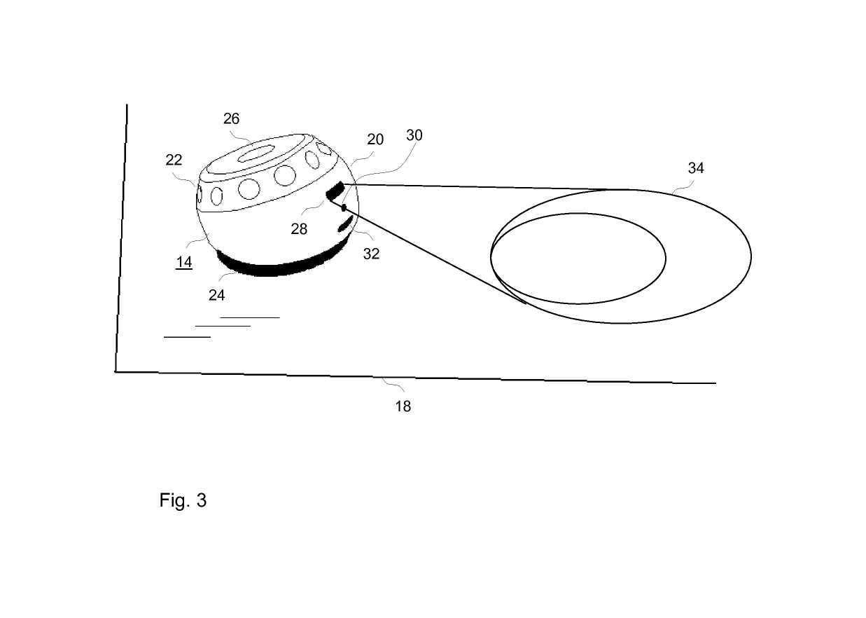

FIG. 3 shows the operating element 14 after it has been removed from the operating unit 12 and placed onto a work surface 18, for instance, a tabletop, a kitchen counter or the like. It can be seen here that the operating element 14, which is shown here in an enlarged view in comparison to FIG. 1 and FIG. 2, has a base part 20 and an operating part 22. The operating part 22 can be moved relative to the base part 20. This figure shows an embodiment of the operating element 14 in which the operating part 22 can be rotated relative to the base part 20. In the embodiment shown, the operating element 14 has an essentially spherical shape with a flat section that functions as its bottom and another flat section that is formed by the top of the operating part 22. Therefore, the operating part 22 has a circular contour and, for the rest, the shape of a spherical disk. Individual depressions, aimed at contributing to the convenient and reliable actuation of the operating part 22, are distributed uniformly along the circumferential surface of the circular contour. There can be a contact surface 24, for instance, a rubber pad, on the flat section of the base part 20 that functions as the bottom. Such a contact surface ensures that the base part 20 stands on the appertaining work surface 18 securely and essentially so that it cannot slip.

In the center of the top of the operating part 22, there is a pushbutton 26 that functions, for instance, as an alarm button and that allows the household appliance 10 to be quickly turned off or switched to a safe state. A projector as well as a camera and/or one or more sensors are located in the base part 20. The projector and the camera or another sensor array cannot be seen in the illustration because they are located inside the base part 20 so that the latter functions as the housing for these units. A first, a second and a third opening 28, 30, 32, however, are visible here and are each intended for a beam path from or for such a unit. Each unit can also be situated directly in such an opening 28-32 and each opening 28-32 is closed by a material that is permeable to the beams in question, for instance, a glass or plastic element. In order to better distinguish between the openings 28-32, reference is hereby made to them below by using the specific designations of the units that are provided there or by using the designations of the units for which or from which radiation strikes through the opening 28-32 in question. The first opening 28, for which one should assume that there is a projector in or behind it, is consequently also designated below as the projector 28. Accordingly, the second opening 30, for which it should be assumed that there is a camera in or behind it, will also be referred to below as the camera 30, and finally, a third opening 32, in which or behind which it should be assumed that there is a sensor array comprising a group of sensors, which will also be referred to as the sensor array 32. Alternatively or cumulatively, the operating element 14 can comprise the camera 30 and the sensor array 32. In each case, either the camera 30 or the sensor array 32 is provided for detecting an operating action. The camera 30 or the sensor array 32 or else the camera 30 and the sensor array 32 can be considered accordingly either individually, or else together as a sensor for detecting an operating action and consequently, the term sensor is employed as a generic term for a camera 30 contained in the operating element 14, or for a sensor array 32 contained in the operating element 14, or for a combination of a camera 30 and a sensor array 32 contained in the operating element 14.

In order to detect an operating action, the projector 28 projects a selection menu 34 onto the work surface 18. The camera 30 can capture an image of the projection and compare it to the projection, in other words, to the selection menu 34 that is being displayed. Deviations between the captured image and the projected selection menu 34 can be due, for example, to the fact that the user's finger or hand is present in an area of the projection, so that, by determining the place where these deviations were ascertained, an operating action by the user is already recognized.

The selection menu 34 is displayed by the projector 28 in physical proximity to the operating element 14 while the selection menu 34 is displayed at least as a function of a specific position of the operating part 22. Therefore, the different positions of the operating part 22 allow different selection menus 34 to be selected and then displayed. The specific selection menu 34 being displayed, however, can depend not only on the position of the operating part 22 but also on a sequence of preceding operating actions recorded by the operating element 14. This permits hierarchically structured selection menus 34 to be loaded and displayed. For instance, first a selection menu 34 that functions as a main menu can be displayed, so that all of the subsequently displayed selection menus 34 depend on a selection made in the main menu or in a selection menu 34 that is arranged on a higher hierarchical level.

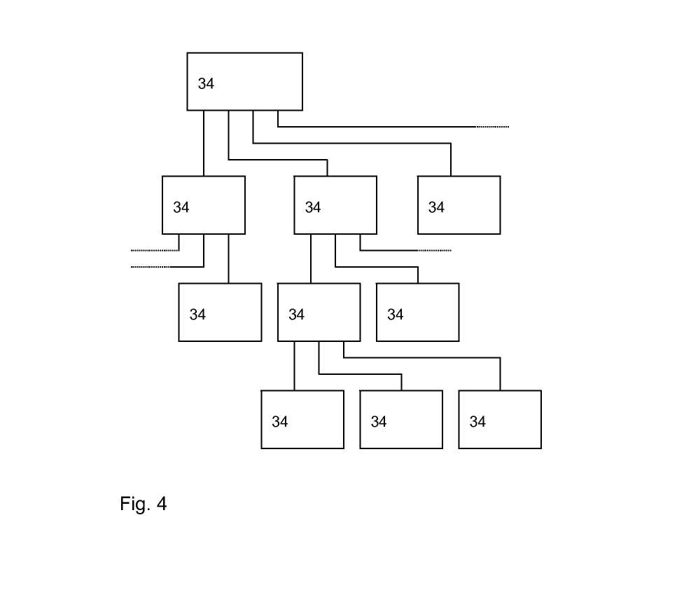

For this purpose, FIG. 4 shows a schematically highly simplified random menu structure with a hierarchically organized arrangement of a number of selection menus 34. Already on the basis of the display provided by way of an example, it is possible to see the capabilities and versatility resulting from a hierarchical structuring of the selection menus 34.

By turning the operating part 22, a selection can be made from among a number of selection menus 34 that are on the same hierarchical level. As an alternative, it can also be provided that turning the operating part 22 causes the options contained in a specific selection menu 34 to rotate, so that it is possible to practically wait before selecting a given option until the desired option “shows up” at a position that can be easily reached by the user's finger, so that the selection of the option can be made by an appropriate operating action.

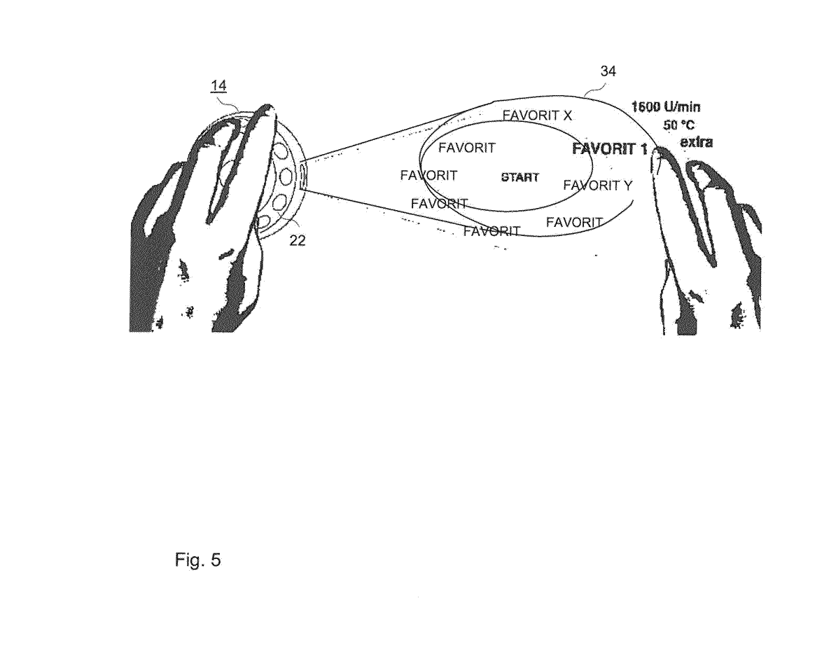

In this context, FIG. 5 shows a snapshot during the use of the operating element 14 by a user. It can be seen that one hand of the user is actuating the operating part 22 of the operating element 14. The operating element 14 projects a selection menu 34 and, in the selection menu 34, the user makes a selection by moving his/her finger or fingertip into the area of a selection option defined in the selection menu 34.

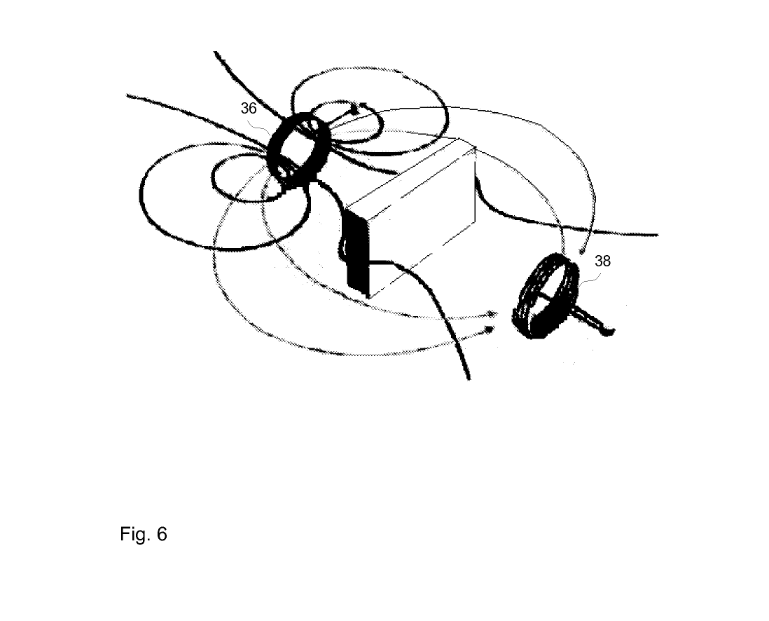

FIG. 6 shows a schematically simplified form of a first coil that functions as a transmitting coil 36, and a complementary second coil that functions as a receiving coil 38. Such a receiving coil 38 can be provided in the operating element 14 in order to induce a current flow in the receiving coil 38 when current is flowing through the transmitting coil 36, and thus in order to charge an electric energy storage unit that supplies the operating element 14 with electricity, in other words, in order to charge, for example, a battery. The transmitting coil 36 is thus located in the operating unit 12 of the household appliance 10, preferably in the area of the docking receptacle 16 that is formed there, so that the energy storage unit of the operating element 14 can be charged when the operating element is joined to the operating unit 12 in the docking receptacle 16 provided for this purpose.

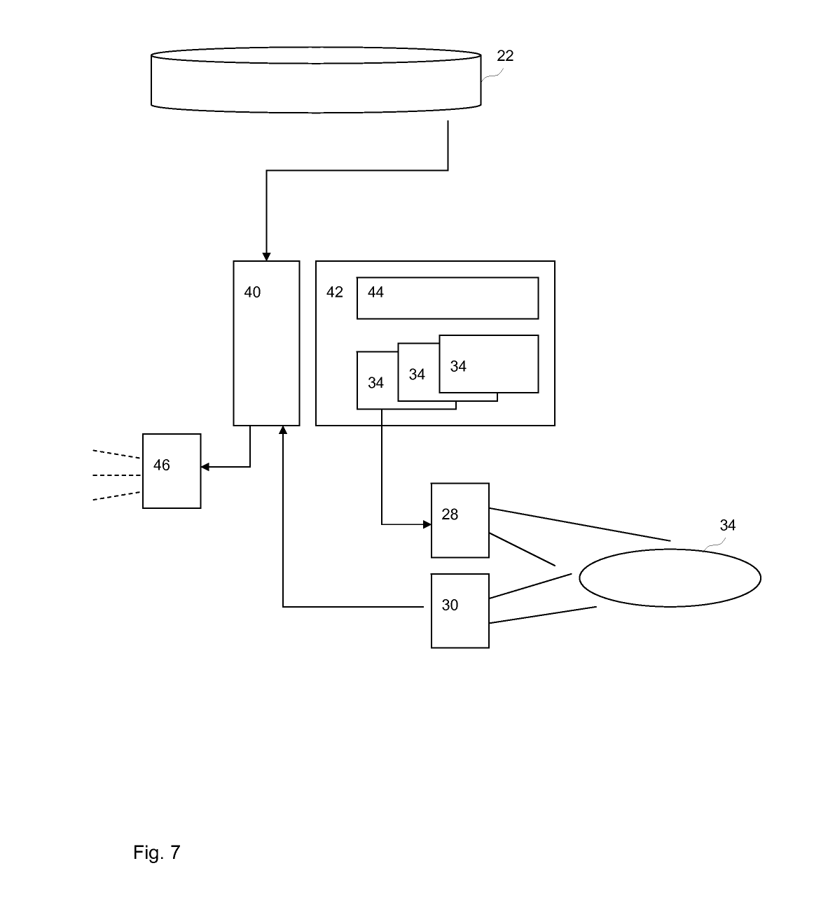

In conclusion, FIG. 7 shows a schematically simplified form of individual cause-effect relationships during the use of the operating element 14. The base part 20 of the operating element 14 comprises a processing unit 40 in the form of or of the type of a microprocessor and a memory 42. During the operation of the operating element 14, the memory 42 contains a control program 44 that determines the functionality of the operating element 14. At the same time, one or more selection menus 34 are in the memory 42. During the operation of the operating element 14, a position of the operating part 22 is detected and a selection menu 34 is displayed on the basis of the detected position. The selection menu 34 is displayed by the projector 28 and any user actions in the area of the display of the selection menu are detected by means of a suitable sensor, for example, the camera 30. Towards this end, the image of the selection menu 34 captured by the camera is analyzed by the processing unit 40. When a user action is recognized, a signal is generated to this effect and transmitted wirelessly, for instance, by a radio transmitter 46, to the operating unit 12 of the household appliance 10 which, for this purpose, has a suitable receiver (not shown here) and evaluates the received signal and initiates appropriate actions vis-à-vis the household appliance 10, for instance, starting a laundry cycle selected by means of the operating unit 12.

While the invention has been particularly shown and described with reference to preferred embodiments thereof, it will be understood by those skilled in the art that various changes in form and details may be made therein without departing from the spirit and scope of the invention.

What is claimed is:

1. An operating element for a household appliance comprising:
a base part including a projector and a sensor; and
an operating part that is movable relative to the base part, wherein the projector of the base part is configured to display a selection menu as a function of a position of the operating part, the selection menu being disposed in physical proximity to the operating element, and wherein the sensor is configured to detect a selection made in the selection menu.

2. The operating element recited in claim 1, wherein the household appliance is stationary.

3. The operating element recited in claim 1, wherein the operating part is rotatable relative to the base part.

4. The operating element recited in claim 1, further comprising a detector for detecting a position of the operating part and a selection device configured to choose a selection menu and to actuate the projector to display the chosen selection menu.

5. The operating element recited in claim 1, wherein the sensor includes a camera and the selection menu is detectable by processing an image captured by the camera.

6. The operating element recited in claim 1, wherein the sensor includes a group of electromagnetic sensors, each oriented in a different radial direction.

7. A system comprising:
an operating unit for a stationary household appliance, the operating unit including a docking receptacle; and
an operating element configured to be placed in the docking receptacle, the operating element including:
a base part including a projector and a sensor, and
an operating part that is movable relative to the base part, wherein the projector of the base part is configured to display a selection menu as a function of a position of the operating part, the selection menu being disposed in physical proximity to the operating element, and wherein the sensor is configured to detect a selection made in the selection menu.

8. The system recited in claim 7, wherein the operating element is detachably securable in the docking receptacle.

9. The system recited in claim 8, wherein the operating element is securable in the docking receptacle magnetically.

10. The system recited in claim 7, wherein the operating unit has a transmitting coil and the operating element has a receiving coil, the transmitting coil being configured to transfer electrical energy to the receiving coil so as to supply electric energy to the operating unit.

11. The system recited in claim 10, wherein the operating element is detachable from the operating unit and usable remotely from the operating unit, and the operating element is configured, during remote use, to transmit data that encodes operating actions from the operating element to the operating unit.

12. The system recited in claim 11, wherein the data is transmitted wirelessly.

13. The system recited in claim 11, wherein the operating unit and the operating element each have at least one of a transmitter or a receiver for wireless communication between the operating unit and the operating element.

14. A household appliance comprising:
an operating element including:
a base part including a projector and a sensor, and
an operating part that is movable relative to the base part, wherein the projector of the base part is configured to display a selection menu as a function of a position of the operating part, the selection menu being disposed in physical proximity to the operating element, and wherein the sensor is configured to detect a selection made in the selection menu.

15. The household appliance recited in claim 14, further comprising operating unit including a docking receptacle configured to receive the operating element.

16. The household appliance recited in claim 15, wherein the operating unit has a transmitting coil and the operating element has a receiving coil, the transmitting coil being configured to transfer electrical energy to the receiving coil so as to supply electric energy to the operating unit.
